(19) United States
(12) Patent Application Publication
(10) Pub. No.: US 2026/0237171 A1
(43) Pub. Date: Aug. 13, 2026

(54) EDITING METHOD OF MULTIMEDIA DATA, ELECTRONIC DEVICE AND STORAGE MEDIUM

(71) Applicant: Beijing Zitiao Network Technology Co., Ltd., Haidian District, Beijing (CN)

(72) Inventors: Yuting ZHU, Beijing (CN); Fan YANG, Beijing (CN); Hao LIU, Beijing (CN); Lei ZHANG, Beijing (CN); Tiangang WANG, Beijing (CN); Xusheng GUO, Beijing (CN); Yunpeng WU, Beijing (CN); Yao ZHANG, Beijing (CN); Zheyuan WANG, Beijing (CN); Xin HUANG, Beijing (CN)

(21) Appl. No.: 19/130,259

(22) PCT Filed: Nov. 14, 2023
(86) PCT No.: PCT/CN2023/131420

§ 371 Date: May 15, 2025

(30) Foreign Application Priority Data
Nov. 15, 2022 (CN) 202211430044.9

(51) Int. Cl. G06T 19/20

(52) U.S. Cl. CPC G06T 19/20; G06T 2219/2004

(57) ABSTRACT

An editing method of multimedia data, an electronic device, and a storage medium are provided. The method includes: in response to an editing trigger operation, displaying a multimedia data editing interface; receiving a scene adding operation input based on the scene configuration item, displaying a virtual scene picture of an added three-dimensional virtual scene in the picture preview region, and displaying a main body configuration item corresponding to the virtual scene picture in the picture editing sub-region; receiving a main body configuration operation for the main body configuration item, and relatively displaying a configured scene main body picture and the virtual scene picture in the picture preview region; and receiving a lens setting operation input based on the lens editing sub-region, and taking a picture displayed in the picture preview region as a broadcast picture of the multimedia data under a lens set based on the lens setting operation.

This application claims the priority of a Chinese patent application filed to the China National Intellectual Property Administration on Nov. 15, 2022, with application number 202211430044.9, the entire content of which is incorporated herein by reference.

### TECHNICAL FIELD

Embodiments of the present disclosure provide an editing method and apparatus of multimedia data, an electronic device and a storage medium.

### BACKGROUND

Virtual broadcast technology is a product of joint development of brand-new modern information technology and traditional multimedia data fabrication technology. At present, the editing of virtual multimedia data usually requires professionals to use a large amount of professional software and hardware for fabrication of multimedia data.

In related technologies, the editing function of multimedia data is limited such that multimedia data and multimedia pictures are relatively fixed, resulting in a relatively rigid and inflexible display effect of the multimedia data, affecting user experience.

### SUMMARY

The present disclosure provides an editing method and apparatus of multimedia data, an electronic device and a storage medium, to implement more flexible editing for broadcast pictures of multimedia data.

In the first aspect, the embodiments of the present disclosure provide an editing method of multimedia data, the method includes:
in response to an editing trigger operation, displaying a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item;
receiving a scene adding operation input based on the scene configuration item, displaying a virtual scene picture of an added three-dimensional virtual scene in the picture preview region, and displaying a main body configuration item corresponding to the virtual scene picture in the picture editing sub-region;
receiving a main body configuration operation for the main body configuration item, and relatively displaying a configured scene main body picture and the virtual scene picture in the picture preview region; and
receiving a lens setting operation input based on the lens editing sub-region, and taking a picture displayed in the picture preview region as a broadcast picture of the multimedia data under a lens set based on the lens setting operation.

In the second aspect, the embodiments of the present disclosure further provide an editing apparatus of multimedia data, the apparatus includes:
an editing interface displaying module, configured to, in response to an editing trigger operation, display a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item;
a virtual scene adding module, configured to receive a scene adding operation input based on the scene configuration item, display a virtual scene picture of an added three-dimensional virtual scene in the picture preview region, and display a main body configuration item corresponding to the virtual scene picture in the picture editing sub-region;
a scene main body configuration module, configured to receive a main body configuration operation for the main body configuration item, and relatively display a configured scene main body picture and the virtual scene picture in the picture preview region; and
a broadcast picture displaying module, configured to receive a lens setting operation input based on the lens editing sub-region, and take a picture displayed in the picture preview region as a broadcast picture of the multimedia data under a lens set based on the lens setting operation.

In the third aspect, the embodiments of the present disclosure further provide an electronic device, the electronic device includes:
one or more processors; and
a storage apparatus, configured to store one or more programs,
the one or more programs, when executed by the one or more processors, cause the one or more processors to implement any one of the above editing methods of multimedia data.

In the fourth aspect, the embodiments of the present disclosure further provide a storage medium having computer executable instructions stored thereon, the computer executable instructions, when executed by a computer processor, are used for executing any one of the above editing methods of multimedia data.

### BRIEF DESCRIPTION OF DRAWINGS

Combining the accompanying drawings and referring to the specific implementation methods below, the above and other features, advantages, and aspects of each embodiment of the present disclosure will become more apparent. Throughout the drawings, the same or similar reference numerals indicate the same or similar components. It should be understood that the attached drawings are illustrative, and the components and elements may not be drawn to scale.

FIG. 1 is a schematic flow chart of an editing method of multimedia data provided by embodiments of the present disclosure;

FIG. 2 is a schematic diagram of an interface of a multimedia data editing interface in an editing method of multimedia data provided by embodiments of the present disclosure;

FIG. 3 is a schematic diagram of an interface of a scene configuration item in an editing method of multimedia data provided by embodiments of the present disclosure;

FIG. 4 is a schematic diagram of an interface of a lens configuration item in an editing method of multimedia data provided by embodiments of the present disclosure;

FIG. 5 is a schematic flow chart of an editing method of multimedia data provided by embodiments of the present disclosure;

FIG. 6 is a schematic flow chart of an editing method of multimedia data provided by embodiments of the present disclosure;

FIG. 7 is a schematic diagram of an interface of an image matting material configuration item in an editing method of multimedia data provided by embodiments of the present disclosure;

FIG. 8 is a schematic flow chart of an editing method of multimedia data provided by embodiments of the present disclosure;

FIG. 9 is a schematic flow chart of an editing method of multimedia data provided by embodiments of the present disclosure;

FIG. 10 is a schematic flow chart of an editing method of multimedia data provided by embodiments of the present disclosure;

FIG. 11 is a structural schematic diagram of an editing apparatus of multimedia data provided by embodiments of the present disclosure; and

FIG. 12 is a structural schematic diagram of an electronic device provided by embodiments of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the implementations of the present disclosure are used for illustrative purposes only, and are not used to limit the scope of these messages or information.

It can be understood that before the technical solution disclosed in each embodiment of the present disclosure is used, the user should be informed of the type, use scope, use scenario, and the like of the personal information involved in the present disclosure in an appropriate manner in accordance with relevant laws and regulations, and the user's authorization should be obtained.

For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure based on the prompt information.

As an optional but non-limiting implementation, in response to receiving the user's active request, for example, the prompt information may be sent to the user in a pop-up window, and the prompt information may be presented in the pop-up window in text. In addition, the pop-up window may also carry a selection control for the user to select “agree” or “disagree” to provide personal information to the electronic device.

It can be understood that the above notification and user authorization obtaining process are only illustrative and do not limit the implementations of the present disclosure. Other methods that comply with relevant laws and regulations may also be applied to the implementations of the present disclosure.

It can be understood that the data involved in this technical solution (including but not limited to the data itself, the acquisition or use of data) should comply with the requirements of corresponding laws and regulations and related regulations.

In the technical solution of the embodiments of the present disclosure, by receiving an editing trigger operation, a multimedia data editing interface is displayed, the multimedia data editing interface displays a picture preview region and a multimedia data editing region, the multimedia data editing region includes a picture editing sub-region and a lens editing sub-region, and the picture editing sub-region displays a scene configuration item, providing a user with a richer interactive interface. By receiving a scene adding operation input based on the scene configuration item, a virtual scene picture of an added three-dimensional virtual scene is displayed in the picture preview region, and a main body configuration item corresponding to the virtual scene picture is displayed in the picture editing sub-region; and by receiving a main body configuration operation for the main body configuration item, a configured scene main body picture and the virtual scene picture are relatively displayed in the picture preview region, which can implement preview of the virtual scene picture and the scene main body picture. On this basis, by receiving a lens setting operation input based on the lens editing sub-region, a picture displayed in the picture preview region is taken as a broadcast picture of multimedia data under a lens set based on the lens setting operation, which implements more flexible editing of the broadcast picture of the multimedia data, and thus improves user experience of the multimedia data.

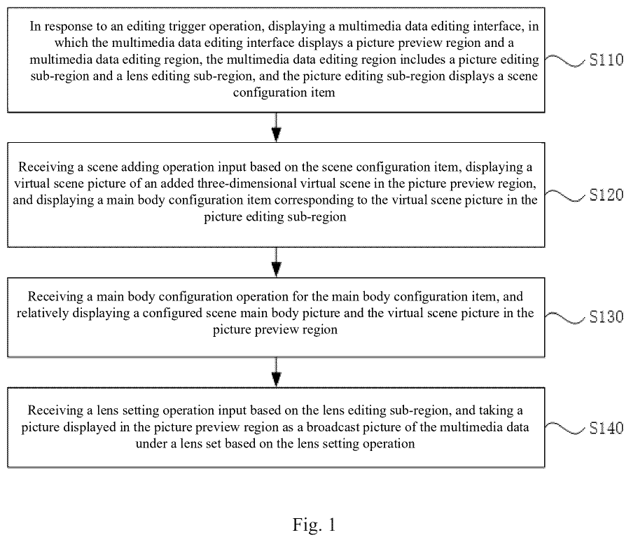

FIG. 1 is a schematic flow chart of an editing method of multimedia data provided by embodiments of the present disclosure; the embodiments of the present disclosure are applicable to a situation of editing multimedia data; the method may be executed by an editing apparatus of multimedia data; the apparatus may be implemented in a form of software and/or hardware, or optionally, implemented through an electronic device; and the electronic device may be a mobile terminal, a PC terminal, or a server, etc.

As shown in FIG. 1, the method according to this embodiment may specifically include:

S110: in response to an editing trigger operation, displaying a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item.

The editing trigger operation may be understood as a trigger operation used for editing multimedia data. There are a variety of generation modes of the editing trigger operation. Specifically, it may be input of an operation used for opening an application or a website for editing multimedia data; or, it may be a trigger operation acting on a preset control or menu item used for triggering display of the multimedia data editing interface. In the embodiments of the present disclosure, after receiving an operation input by a user that is used for opening an application or a website for editing multimedia data, or, after receiving a trigger operation acting on a preset control or menu item used for triggering display of the multimedia data editing interface, the multimedia data editing interface may be displayed.

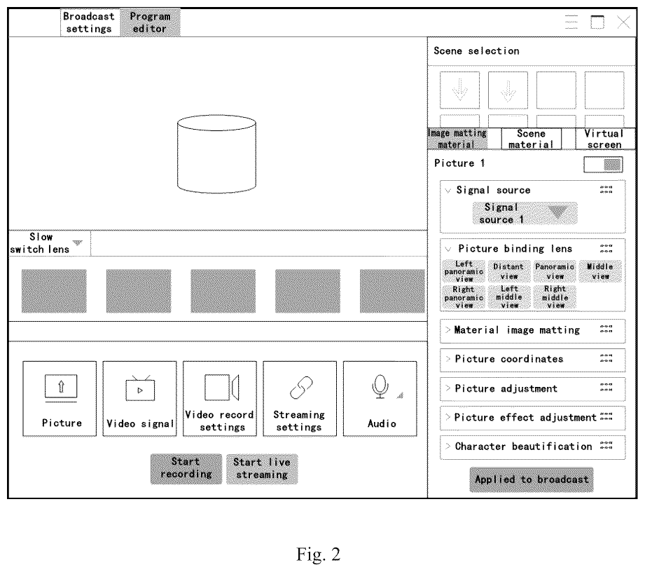

In the embodiments of the present disclosure, the multimedia data editing interface may be understood as a visual interface used for editing multimedia data. The multimedia data may be understood as multimedia data obtained by processing based on at least one group of multimedia data resources and may be used for broadcast in a preset broadcast space. In the embodiments of the present disclosure, the multimedia data resource may be understood as a resource that can be used for configuring a broadcast picture of the multimedia data, for example, may include at least one of a group consisting of a virtual scene resource, a video source, or a scene material. The preset broadcast space may be a live streaming room and/or a television station, etc. The multimedia data editing interface (referring to FIG. 2) may display the picture preview region and the multimedia data editing region. The picture preview region may be understood as a region used for previewing a multimedia data picture in the multimedia data editing interface. In other words, the picture preview region may be used for playing the multimedia data picture. The multimedia data editing region may be understood as a region used for editing the multimedia data picture in the multimedia data editing interface. The multimedia data editing region may include the picture editing sub-region and the lens editing sub-region. The lens editing sub-region may be understood as a region used for configuring correspondence between the multimedia data picture and a display lens in the multimedia data editing region. The picture editing sub-region may be understood as a region used for editing the multimedia data picture in the multimedia data editing region. The picture editing sub-region may display the scene configuration item. The scene configuration item may be used for configuring a three-dimensional virtual scene used by the multimedia data.

It should be noted that an arrangement mode of the picture preview region and the multimedia data editing region in the multimedia data editing interface may be set according to actual needs, and will not be specifically limited here.

S120: receiving a scene adding operation input based on the scene configuration item, displaying a virtual scene picture of an added three-dimensional virtual scene in the picture preview region, and displaying a main body configuration item corresponding to the virtual scene picture in the picture editing sub-region.

The scene adding operation may be understood as an operation used for adding a three-dimensional virtual scene to multimedia data. The scene adding operation may trigger execution of operations of displaying the virtual scene picture of the added three-dimensional virtual scene in the picture preview region, and displaying the main body configuration item corresponding to the virtual scene picture in the picture editing sub-region. The virtual scene picture may be a picture obtained after rendering the three-dimensional virtual scene. It may be understood that the display picture of the virtual scene picture is associated with a camera parameter of a virtual camera in the three-dimensional virtual scene. The scene main body picture may be a picture obtained after rendering a main body corresponding to the three-dimensional virtual scene. Exemplarily, the main body corresponding to the virtual scene picture may be a three-dimensional studio model, a screen display material (e.g., an image, a video, etc.) displayed on a virtual screen, and a person or an object in a real scene. The three-dimensional virtual scene may be understood as a three-dimensional scene constructed based on computer vision technology. Specifically, the three-dimensional virtual scene may include one or more scene elements; and the scene element may be constructed based on a three-dimensional model. In practical applications, the number of three-dimensional models in the three-dimensional virtual scene may be one, two, or more than two. The picture editing sub-region may include at least one main body configuration item. The main body configuration item may be understood as a configuration item used for configuring the scene main body picture corresponding to the virtual scene picture.

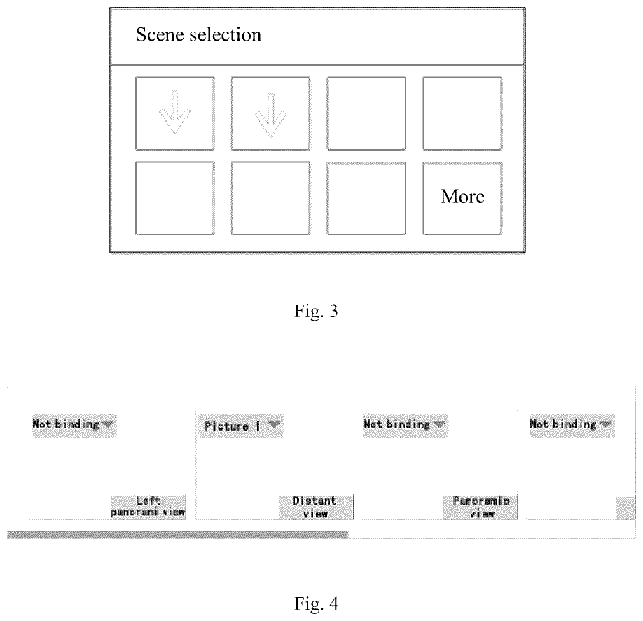

In one embodiment, the receiving a scene adding operation input based on the scene configuration item, and displaying a virtual scene picture of an added three-dimensional virtual scene in the picture preview region, may include: receiving a trigger operation acting on the scene configuration item (“scene selection” in FIG. 3), and displaying a scene selection interface. The scene selection interface displays at least one three-dimensional virtual scene item. The three-dimensional virtual scene item may include both a three-dimensional virtual scene item having not been downloaded (a scene item with a download icon in FIG. 3) and a downloaded three-dimensional virtual scene item (a scene item without a download icon in FIG. 3). In response to the trigger operation acting on the three-dimensional virtual scene item, the three-dimensional virtual scene of the selected three-dimensional virtual scene item may be taken as the added three-dimensional virtual scene, the virtual scene picture of the added three-dimensional virtual scene is acquired, and the virtual scene picture is displayed in the picture preview region.

In another embodiment, the receiving a scene adding operation input based on the scene configuration item, and displaying a virtual scene picture of an added three-dimensional virtual scene in the picture preview region, may include: receiving a dragging operation acting on the three-dimensional virtual scene item in the scene selection interface; displaying, in the picture preview region, the virtual scene picture of the three-dimensional virtual scene corresponding to the three-dimensional virtual scene item dragged to a preset region. The preset region may be the picture preview region, or may also be other region in the multimedia data editing interface except the picture preview region.

In the embodiments of the present disclosure, after displaying the virtual scene picture of the added three-dimensional virtual scene in the picture preview region, the main body configuration item corresponding to the virtual scene picture may be determined, and the main body configuration item is displayed in the picture editing sub-region, to receive an operation of configuring the main body configuration item corresponding to the virtual scene picture input by the user based on the picture editing sub-region.

S130: receiving a main body configuration operation for the main body configuration item, and relatively displaying a configured scene main body picture and the virtual scene picture in the picture preview region.

The main body configuration operation may be understood as an operation used for configuring the scene main body picture corresponding to the virtual scene picture based on the main body configuration item. The configured scene main body picture may be understood as a picture obtained after configuring the scene main body picture based on the main body configuration operation acting on the main body configuration item.

Specifically, by receiving the main body configuration operation acting on the main body configuration item, main body configuration information of the main body configuration item may be acquired. Further, the configured scene main body picture may be obtained based on the main body configuration information. After obtaining the configured scene main body picture, the configured scene main body picture and the virtual scene picture may be relatively displayed in the picture preview region.

Optionally, the receiving a main body configuration operation for the main body configuration item, and relatively displaying the configured scene main body picture and the virtual scene picture in the picture preview region, may include: receiving a trigger operation acting on a region where the main body configuration item is located, and displaying at least one main body configuration sub-item corresponding to the main body configuration item based on the trigger operation. After receiving a configuration operation for the at least one main body configuration sub-item, configuration information for respective main body configuration sub-items may be acquired. Further, the configured scene main body picture may be obtained based on the configuration information of the respective main body configuration sub-items. After obtaining the configured scene main body picture, the configured scene main body picture and the virtual scene picture may be relatively displayed in the picture preview region.

S140: receiving a lens setting operation input based on the lens editing sub-region, and taking a picture displayed in the picture preview region as a broadcast picture of the multimedia data under a lens set based on the lens setting operation.

The lens setting operation may be used for setting association between the displayed picture in the picture preview region and the lens. The lens setting operation may include at least one of a group consisting of a lens binding operation, a lens adding operation, and a lens deleting operation. The lens binding operation may be understood as an operation used for binding a lens under a certain perspective with the picture displayed in the picture preview region. In other words, the lens binding operation may be used for binding the virtual scene picture and/or the scene main body picture with the operated lens. The lens editing sub-region may include at least one lens configuration item. The lens configuration item may be used for binding the lens under a perspective corresponding to the lens configuration item with the picture displayed in the picture preview region.

Optionally, the receiving a lens setting operation input based on the lens editing sub-region, and taking the picture displayed in the picture preview region as a broadcast picture of the multimedia data under a lens set based on the lens setting operation, includes: receiving a lens binding operation input based on the lens editing sub-region, and taking the picture displayed in the picture preview region as a broadcast picture of the multimedia data under a lens bound based on the lens binding operation.

Specifically, the trigger operation acting on the lens configuration item in the lens editing sub-region is received. Based on the click operation, an editing state of the clicked lens configuration item is set to an editable state. The lens configuration item in the editable state may include a picture binding sub-item. The picture binding sub-item may include an item corresponding to a picture that may be bound to the lens or an item corresponding to a picture that is not bound to the lens. After receiving the trigger operation acting on the item corresponding to the picture that may be bound to the lens (e.g., a picture identifier, the picture identifier is, for example, “picture 1” in FIG. 4), the picture corresponding to the item may be bound to the lens. Further, after receiving the trigger operation acting on the item corresponding to the picture that is not bound to the lens, a binding relationship between the lens and the picture may be released. In the embodiments of the present disclosure, optionally, a correspondence between the three-dimensional virtual scene and the lens configuration item is prebuilt. Different three-dimensional virtual scenes may correspond to the same lens configuration item or different lens configuration items. One three-dimensional virtual scene may correspond to one or more lens configuration items. Further, each lens configuration item may bind a virtual scene picture under a group of camera parameters in the three-dimensional virtual scene.

In the embodiments of the present disclosure, after receiving the lens binding operation input based on the lens editing sub-region, the picture under a shooting perspective of the bound lens may be obtained and displayed in the picture preview region. Further, the picture displayed in the picture preview region may be taken as the broadcast picture of the multimedia data under the bound lens.

On the basis of the above-described embodiment, the editing method of multimedia data further includes: receiving a display adjusting operation for at least one lens configuration item, and adjusting a display mode of the at least one lens configuration item in the lens configuration sub-region.

The display adjusting operation may be used for adjusting the display mode of the lens configuration item displayed in the lens configuration sub-region. The display adjusting operation may include a display position adjusting operation and/or a display quantity adjusting operation. The display position adjusting operation may be understood as an operation used for adjusting a position of the lens configuration item in the lens configuration sub-region. The display quantity adjusting operation may be understood as an operation used for adding or deleting the lens configuration item in the lens configuration sub-region.

In the embodiments of the present disclosure, the adjusting a display mode of the at least one lens configuration item in the lens configuration sub-region, may include: adjusting the display quantity of the at least one lens configuration item in the lens configuration sub-region.

In one embodiment, the adjusting the display quantity of the at least one lens configuration item in the lens configuration sub-region, may include: receiving a trigger operation acting on the lens configuration item, and displaying a delete control used for deleting the lens configuration item. After receiving a trigger operation acting on the delete control, the lens configuration item displayed in the lens configuration sub-region may be deleted.

In another embodiment, the adjusting the display quantity of the at least one lens configuration item in the lens configuration sub-region, may include: displaying an add control used for adding a lens configuration item after receiving a trigger operation acting on the lens configuration item. After receiving a trigger operation acting on the add control, the lens configuration item may be added in the lens configuration sub-region.

In the embodiments of the present disclosure, the adjusting a display mode of the at least one lens configuration item in the lens configuration sub-region, may include: adjusting the display position of the at least one lens configuration item in the lens configuration sub-region. Specifically, a dragging operation acting on the lens configuration item is received; and the display position for displaying the at least one lens configuration item in the lens configuration sub-region is adjusted based on the dragging operation. The operation of adjusting the display position includes but is not limited to inserting the dragged lens configuration item in a dragging end position, or swapping a position of the dragged lens configuration item with the lens configuration item in the dragging end position.

In the technical solution of the embodiments of the present disclosure, by receiving the editing trigger operation, the multimedia data editing interface is displayed, the multimedia data editing interface displays the picture preview region and the multimedia data editing region, the multimedia data editing region includes the picture editing sub-region and the lens editing sub-region, and the picture editing sub-region displays the scene configuration item, providing the user with a richer interactive interface. By receiving the scene adding operation input based on the scene configuration item, the virtual scene picture of the added three-dimensional virtual scene is displayed in the picture preview region, and the main body configuration item corresponding to the virtual scene picture is displayed in the picture editing sub-region; and by receiving the main body configuration operation for the main body configuration item, the configured scene main body picture and the virtual scene picture are relatively displayed in the picture preview region, which can implement flexible personalized editing of the virtual scene picture and the scene main body picture. On this basis, by receiving the lens setting operation input based on the lens editing sub-region, the picture displayed in the picture preview region is taken as the broadcast picture of the multimedia data under the bound lens, which implements flexible configuration of the broadcast picture of the multimedia data.

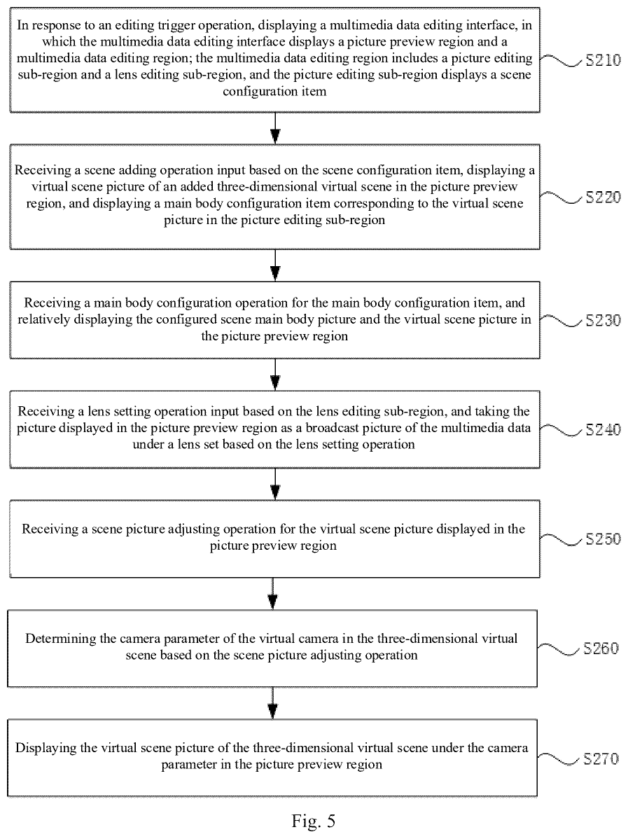

FIG. 5 is a schematic flow chart of an editing method of multimedia data provided by embodiments of the present disclosure. In the technical solution of this embodiment, on the basis of the above-described embodiment, optionally, the method further includes: receiving a scene picture adjusting operation for the virtual scene picture displayed in the picture preview region, determining a camera parameter of a virtual camera in the three-dimensional virtual scene based on the scene picture adjusting operation; and displaying a virtual scene picture of the three-dimensional virtual scene under the camera parameter in the picture preview region. The description of this embodiment may be referred to for specific implementation. Technical features that are the same as or similar to the foregoing embodiments will not be repeated here.

As shown in FIG. 5, the method according to this embodiment may specifically include:

S210: in response to an editing trigger operation, displaying a multimedia data editing interface, in which the multimedia data editing interface displays a picture preview region and a multimedia data editing region; the multimedia data editing region includes a picture editing sub-region and a lens editing sub-region, and the picture editing sub-region displays a scene configuration item.

S220: receiving a scene adding operation input based on the scene configuration item, displaying a virtual scene picture of an added three-dimensional virtual scene in the picture preview region, and displaying a main body configuration item corresponding to the virtual scene picture in the picture editing sub-region.

S230: receiving a main body configuration operation for the main body configuration item, and relatively displaying the configured scene main body picture and the virtual scene picture in the picture preview region.

S240: receiving a lens setting operation input based on the lens editing sub-region, and taking the picture displayed in the picture preview region as a broadcast picture of the multimedia data under a lens set based on the lens setting operation.

S250: receiving a scene picture adjusting operation for the virtual scene picture displayed in the picture preview region.

The scene picture adjusting operation may be understood as an operation used for adjusting the virtual scene picture. In other words, the scene picture adjusting operation may be used for adjusting a virtual scene picture under one perspective to a virtual scene picture under another perspective. Optionally, the receiving a scene picture adjusting operation for the virtual scene picture displayed in the picture preview region, may be: receiving an operation used for adjusting the virtual scene picture displayed in the picture preview region input by a user based on an input device. The device may be a physical input device (e.g., a mouse and/or a keyboard) and a virtual input device (e.g., a virtual keyboard). The virtual camera may be understood as a camera used for shooting the three-dimensional virtual scene. The camera parameter of the virtual camera may be used for indicating a shooting perspective of the virtual camera for shooting the three-dimensional virtual scene. Exemplarily, a key press operation used for adjusting the virtual scene picture input by the user based on the keyboard is received.

S260: determining the camera parameter of the virtual camera in the three-dimensional virtual scene based on the scene picture adjusting operation.

Specifically, operation information of the scene picture adjusting operation is determined. The operation information may include position adjustment information and/or perspective adjustment information. Further, the camera parameter of the virtual camera in the three-dimensional virtual scene may be determined according to the position adjustment information and/or the perspective adjustment information. The position adjustment information may be information obtained after adjusting a position of the virtual camera in the three-dimensional virtual scene. The perspective adjustment information may be information obtained after rotating a lens of the virtual camera in the three-dimensional virtual scene.

S270: displaying the virtual scene picture of the three-dimensional virtual scene under the camera parameter in the picture preview region.

Specifically, the virtual scene picture of the three-dimensional virtual scene under the camera parameter is acquired, and the virtual scene picture is displayed in the picture preview region. The mode of acquiring the virtual scene picture of the three-dimensional virtual scene under the camera parameter may specifically be: shooting the three-dimensional virtual scene based on the virtual camera of the camera parameter. Thus, the virtual scene picture of the three-dimensional virtual scene under the camera parameter may be obtained.

On the basis of the above-described embodiment, the editing method of multimedia data further includes: receiving a scene picture saving operation for the virtual scene picture displayed in the picture preview region, generating a lens configuration item based on the camera parameter corresponding to the virtual scene picture, and displaying the lens configuration item in the lens editing sub-region.

The scene picture saving operation may be understood as an operation used for saving the virtual scene picture displayed in the picture preview region.

Specifically, a trigger operation acting on the virtual scene picture displayed in the picture preview region is received, so that a prompt interface used for saving or canceling saving the triggered virtual scene picture may be displayed. The prompt interface may include a saving control used for saving the virtual scene picture and a cancel control used for canceling saving the virtual scene picture. After receiving a trigger operation acting on the saving control, the camera parameter corresponding to the virtual scene picture may be determined. Further, the lens configuration item may be generated based on the camera parameter. After generating the configuration item, the generated lens configuration item may be displayed in the lens editing sub-region.

In the technical solution of the embodiments of the present disclosure, by receiving the scene picture adjusting operation for the virtual scene picture displayed in the picture preview region, the camera parameter of the virtual camera in the three-dimensional virtual scene is determined based on the scene picture adjusting operation; and the virtual scene picture of the three-dimensional virtual scene under the camera parameter is displayed in the picture preview region, which can implement personalized adjustment of the shooting perspective of the three-dimensional virtual scene, and enrich a visual presentation effect of the multimedia data.

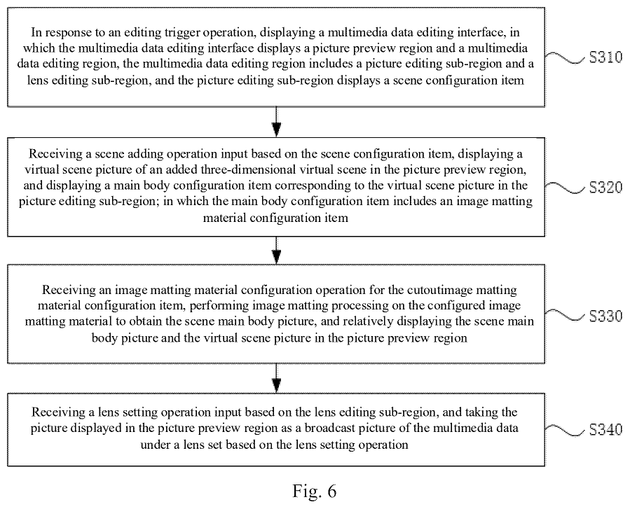

FIG. 6 is a schematic flow chart of an editing method of multimedia data provided by embodiments of the present disclosure. In the technical solution of this embodiment, on the basis of the above-described embodiment, optionally, the main body configuration item includes an image matting material configuration item; the receiving a main body configuration operation for the main body configuration item, and relatively displaying the configured scene main body picture and the virtual scene picture in the picture preview region, includes: receiving an image matting material configuration operation for the image matting material configuration item, performing image matting processing on the configured image matting material to obtain the scene main body picture, and relatively displaying the scene main body picture and the virtual scene picture in the picture preview region. The description of this embodiment may be referred to for specific implementation. Technical features that are the same as or similar to the foregoing embodiments will not be repeated here.

As shown in FIG. 6, the method according to this embodiment may specifically include:

S310: in response to an editing trigger operation, displaying a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item.

S320: receiving a scene adding operation input based on the scene configuration item, displaying a virtual scene picture of an added three-dimensional virtual scene in the picture preview region, and displaying a main body configuration item corresponding to the virtual scene picture in the picture editing sub-region; in which the main body configuration item includes an image matting material configuration item.

In the embodiments of the present disclosure, the image matting material configuration item may be understood as a configuration item used for performing image matting on the image matting material. The image matting material may include a video and/or an image. The image matting material configuration item may include at least one of a group consisting of a signal source configuration sub-item, a lens configuration sub-item, and an image matting mode configuration sub-item. The signal source configuration sub-item may be understood as an item for configuring a source of the image matting material. The lens configuration sub-item may be understood as a configuration item used for binding a picture and a display lens. The image matting mode configuration sub-item may be understood as a configuration item used for setting a material image matting mode. Optionally, the material image matting mode may be an image matting mode in a green screen mode. The image matting mode in the green screen mode may include at least one of a group consisting of intelligent image matting, custom parameter image matting, and image matting by triggering a picture.

S330: receiving an image matting material configuration operation for the image matting material configuration item, performing image matting processing on the configured image matting material to obtain the scene main body picture, and relatively displaying the scene main body picture and the virtual scene picture in the picture preview region.

In the embodiments of the present disclosure, a trigger operation acting on the image matting material configuration item is received, so that at least one of a group consisting of the signal source configuration sub-item, the lens configuration sub-item, and the image matting mode configuration sub-item corresponding to the image matting material configuration item may be displayed.

In one embodiment, a trigger operation acting on the signal source configuration sub-item is received, so that a signal source selection dropdown list including a plurality of signal source options may be displayed. After receiving a select operation acting on a signal source option in the signal source selection dropdown list, an image matting material may be acquired based on a selected signal source, that is, a configured image matting material may be acquired.

In one embodiment, a trigger operation acting on the lens configuration sub-item is received, so that a control corresponding to the lens configuration sub-item and used for binding a lens under a preset perspective and a picture may be displayed. The preset perspective may include at least one perspective among a distant view perspective, a left panoramic view perspective, a panoramic view perspective, a middle view perspective, a right panoramic view perspective, a left middle view perspective, a right middle view perspective, a left close view perspective, a distant view perspective, and a right close view perspective. After receiving a trigger operation acting on a control used for binding a lens under the distant view perspective and a picture, an image matting material bound to the lens under the distant view perspective may be taken as the scene main body picture and displayed in the picture preview region.

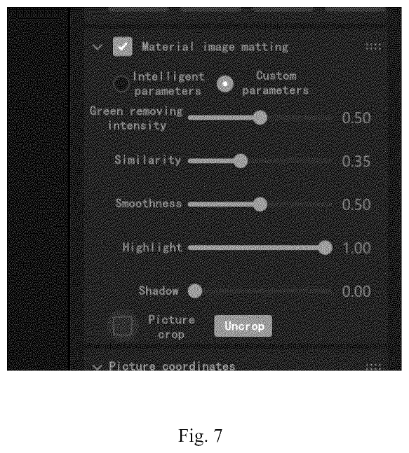

In one embodiment, in a case where the image matting material bound to the lens under the distant view perspective is displayed as the scene main body picture in the picture preview region, a trigger operation acting on the image matting material configuration item (“Image matting material” in FIG. 7) is received, so that an image matting mode setting item used for setting a material image matting mode may be displayed. The image matting mode setting item may include at least one of a group consisting of an intelligent parameter setting item, a custom parameter setting item, and a picture crop setting item. After receiving a trigger operation acting on the at least one of the intelligent parameter setting item, the custom parameter setting item, and the picture crop setting item, image matting processing may be performed on the configured image matting material based on the trigger operation.

In the embodiments of the present disclosure, after receiving a trigger operation acing on the intelligent parameter setting item, an image matting intelligent recommendation parameter value of the intelligent parameter setting item may be acquired; and further, image matting processing may be performed on the configured image matting material based on the image matting intelligent recommendation parameter value.

In the embodiments of the present disclosure, after receiving a trigger operation on the custom parameter setting item, an image matting parameter setting interface corresponding to a selected setting item and used for performing image matting setting on the image matting material may be displayed; after receiving a setting operation acting on the image matting parameter setting interface receiving the input, an image matting parameter value for performing image matting setting on the image matting material may be obtained; and further, image matting processing may be performed on the configured image matting material based on the image matting parameter value.

In the embodiments of the present disclosure, after receiving a trigger operation acting on at least one of the picture crop setting item, a cropping box corresponding to the image matting material is displayed in the picture of the picture preview region. After receiving a crop operation acting on the cropping box, image matting processing may be performed on the configured image matting material based on the crop operation.

In the embodiments of the present disclosure, after image matting processing is performed on the configured image matting material, the cropped image matting material may be rendered. Further, the rendered picture may be taken as the scene main body picture. Further, the scene main body picture and the virtual scene picture may be relatively displayed in the picture preview region.

In the embodiments of the present disclosure, for convenience of image matting, the image matting material may be a green screen background material including a scene subject.

S340: receiving a lens setting operation input based on the lens editing sub-region, and taking the picture displayed in the picture preview region as a broadcast picture of the multimedia data under a lens set based on the lens setting operation.

In the technical solution of the embodiments of the present disclosure, by receiving the image matting material configuration operation for the image matting material configuration item, image matting processing is performed on the configured image matting material, to obtain the scene main body picture, and the scene main body picture and the virtual scene picture are relatively displayed in the picture preview region, so that addition of personalized and diversified scene main body pictures is supported, fine fusion of the scene main body picture and the virtual scene picture can be implemented, which is particularly suitable for a scene where the virtual scene picture is combined with a real shot picture, and further, real-time image matting of the image matting material is supported, which improves editing efficiency of the multimedia data.

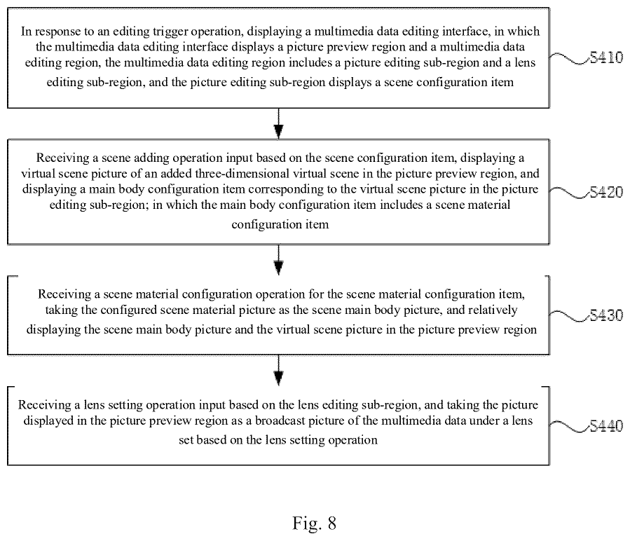

FIG. 8 is a schematic flow chart of an editing method of multimedia data provided by embodiments of the present disclosure. In the technical solution of this embodiment, on the basis of the above-described embodiment, optionally, the main body configuration item includes a scene material configuration item; and the receiving a main body configuration operation for the main body configuration item, and relatively displaying the configured scene main body picture and the virtual scene picture in the picture preview region, includes: receiving a scene material configuration operation for the scene material configuration item, taking the configured scene material picture as the scene main body picture, and relatively displaying the scene main body picture and the virtual scene picture in the picture preview region. The description of this embodiment may be referred to for specific implementation. Technical features that are the same as or similar to the foregoing embodiments will not be repeated here.

As shown in FIG. 8, the method according to this embodiment may specifically include:

S410: in response to an editing trigger operation, displaying a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item.

S420: receiving a scene adding operation input based on the scene configuration item, displaying a virtual scene picture of an added three-dimensional virtual scene in the picture preview region, and displaying a main body configuration item corresponding to the virtual scene picture in the picture editing sub-region; in which the main body configuration item includes a scene material configuration item.

The scene material configuration item may be understood as a configuration item used for configuring a scene material. The scene material may include a three-dimensional material and/or a two-dimensional material. The scene material may be a material having an effect, or may also be a material having no effect. The scene material configuration item may include at least one of a group consisting of a material addition setting sub-item, a material adjustment setting sub-item, and a material deletion setting sub-item. The material addition setting sub-item may be used for adding a material in the three-dimensional virtual scene. The material adjustment setting sub-item may be used for adjusting a material in a scene. The material deletion setting sub-item may be used for deleting a material in the three-dimensional virtual scene.

S430: receiving a scene material configuration operation for the scene material configuration item, taking the configured scene material picture as the scene main body picture, and relatively displaying the scene main body picture and the virtual scene picture in the picture preview region.

The scene material configuration operation may be understood as an operation used for configuring a material in the three-dimensional virtual scene based on the scene material configuration item. The scene material configuration operation may include at least one of a group consisting of a scene material adding operation, a scene material adjusting operation, a scene material deleting operation, and a scene material naming operation. The scene material adding operation may be understood as an operation of adding a scene material in the three-dimensional virtual scene. The scene material adjusting operation may be used for adjusting the scene material in the three-dimensional virtual scene, for example, adjusting a position and/or a size of the scene material in the three-dimensional virtual scene. The scene material deleting operation may be understood as an operation used for deleting the scene material in the three-dimensional virtual scene.

In the embodiments of the present disclosure, a trigger operation acting on the scene material configuration item in the picture editing sub-region is received, so that a scene material configuration interface used for configuring the scene material may be displayed. The scene material configuration interface may include at least one of a group consisting of a material addition setting sub-item, at least one added scene material sub-item, a material adjustment setting sub-item corresponding to each added scene material sub-item, and a material deletion setting sub-item corresponding to each added scene material sub-item.

In one embodiment, after receiving a trigger operation acting on the material addition setting sub-item, a scene material resource library interface may be displayed. The scene material resource library interface may include at least one scene material item, a selection confirming control, and a selection canceling control. After receiving a selection operation acting on the at least one scene material item acting on the scene material resource library interface, the scene material corresponding to the selected scene material item may be determined. After receiving a trigger operation acting on the selection confirming control, the scene material corresponding to the selected scene material item may be added to the three-dimensional virtual scene in the picture preview region, and the selected scene material item added to the three-dimensional virtual scene may be displayed on the scene material configuration interface; in other words, the added scene material sub-item may be displayed on the scene material configuration interface. It may be understood that after receiving a trigger operation acting on the selection canceling control, selection of the scene material item in the scene material resource library interface may be canceled.

In one embodiment, after receiving a trigger operation acting on the material adjustment setting sub-item corresponding to the added scene material sub-item, a material parameter adjustment interface used for adjusting the scene material corresponding to the added scene material sub-item may be displayed. The material parameter adjustment interface may display a material size adjustment item and/or a material position setting item. The material size adjustment item may be used for adjusting the size of the scene material. The material position setting item may be used for setting the position of the scene material. After receiving an adjusting operation acting on the material size adjustment item, a target size of the scene material may be determined. Further, the scene material in the three-dimensional virtual scene displayed in the picture preview region may be scaled and displayed in the picture preview region with the target size of the scene material. After receiving a parameter value (e.g., a spatial coordinate value) input based on the material position adjustment item, the scene material may be displayed in a position corresponding to the input parameter value in the three-dimensional virtual scene in the picture preview region.

In one embodiment, after receiving a trigger operation acting on the material deletion setting sub-item corresponding to the added scene material sub-item, the scene material corresponding to the added scene material sub-item in the three-dimensional virtual scene may be deleted, and the added scene material sub-item in the scene material configuration interface may be deleted.

On the basis of the above-described embodiments, after configuring the scene material in the three-dimensional virtual scene based on the scene material configuration operation, the already configured scene material may be rendered. Thus, a configured scene material picture may be obtained. In this case, the configured scene material picture may be taken as the scene main body picture. Further, the scene main body picture and the virtual scene picture may be relatively displayed in the picture preview region.

In the embodiments of the present disclosure, the method further includes: after receiving a trigger operation acting on a text box including a material name in the added scene material sub-item, modifying an editing state of the text box to an editable state. After receiving material name information input based on the text box whose editing state is the editable state, the input material name information may be taken as a material name of the scene material corresponding to the added scene material sub-item.

S440: receiving a lens setting operation input based on the lens editing sub-region, and taking the picture displayed in the picture preview region as a broadcast picture of the multimedia data under a lens set based on the lens setting operation.

In the technical solution of the embodiments of the present disclosure, by receiving the scene material configuration operation for the scene material configuration item, the configured scene material picture is taken as the scene main body picture, and the scene main body picture and the virtual scene picture are relatively displayed in the picture preview region, which can implement personalized configuration for the scene material, and further enrich a display effect of the multimedia data.

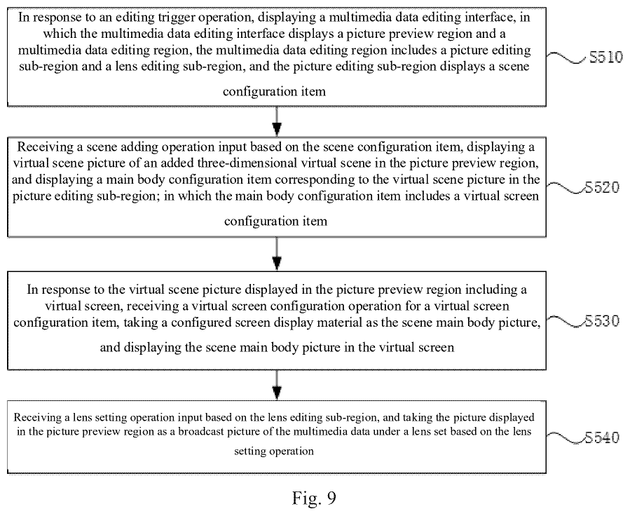

FIG. 9 is a schematic flow chart of an editing method of multimedia data provided by embodiments of the present disclosure. In the technical solution of this embodiment, on the basis of the above-described embodiment, optionally, the main body configuration item includes a virtual screen configuration item; and the receiving a main body configuration operation for the main body configuration item, and relatively displaying the configured scene main body picture and the virtual scene picture in the picture preview region, includes: in response to the virtual scene picture displayed in the picture preview region including a virtual screen, receiving a virtual screen configuration operation for a virtual screen configuration item, taking a configured screen display material as the scene main body picture, and displaying the scene main body picture in the virtual screen. The description of this embodiment may be referred to for specific implementation. Technical features that are the same as or similar to the foregoing embodiments will not be repeated here.

As shown in FIG. 9, the method according to this embodiment may specifically include:

S510: in response to an editing trigger operation, displaying a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item.

S520: receiving a scene adding operation input based on the scene configuration item, displaying a virtual scene picture of an added three-dimensional virtual scene in the picture preview region, and displaying a main body configuration item corresponding to the virtual scene picture in the picture editing sub-region; in which the main body configuration item includes a virtual screen configuration item.

The virtual screen configuration item may be understood as a configuration item used for configuring the virtual screen. The virtual screen may be understood as a screen used for displaying a screen display material. The screen display material may include at least one of a group consisting of a video material, a text material, and an image material. A format of the video material may include an mp4 format, an avi format, a wmv format, etc. A format of the image material may be at least one of a jpg format, a png format, or a gif format. The virtual screen configuration item may include a multimedia material setting sub-item and/or a signal source setting sub-item. The multimedia material setting sub-item may be used for setting a multimedia material, for example, adding a multimedia material and/or deleting a multimedia material, in a case where the screen display material displayed on the virtual screen comes from the multimedia material. The signal source setting sub-item may be used for setting a signal source in a case where the screen display material displayed on the virtual screen comes from the signal source.

S530: in response to the virtual scene picture displayed in the picture preview region including a virtual screen, receiving a virtual screen configuration operation for a virtual screen configuration item, taking a configured screen display material as the scene main body picture, and displaying the scene main body picture in the virtual screen.

The virtual screen configuration operation may be understood as an operation used for configuring the virtual screen displayed in the virtual scene picture. The virtual screen configuration operation may include at least one of a group consisting of a screen display material adding operation, a screen display material deleting operation, a screen display material playback operation, and a screen display material pause operation. The screen display material adding operation may be used for adding a screen display material in the virtual screen. The screen display material deleting operation may be used for deleting a screen display material in the virtual screen. The screen display material playback operation may be used for controlling playback of the screen display material in the virtual screen. The screen display material pause operation may be used for controlling pausing playback of the screen display material played in the virtual screen.

In the embodiments of the present disclosure, in a case where the virtual scene picture displayed in the picture preview region includes the virtual screen, a trigger operation acting on the virtual screen configuration item is received, so that the multimedia material setting sub-item and/or the signal source setting sub-item corresponding to the virtual screen configuration item may be displayed. Optionally, the multimedia material setting sub-item and/or the signal source setting sub-item may be displayed in a form of a dropdown list.

On the basis of the above-described embodiment, after receiving a trigger operation acting on the multimedia material setting sub-item for the virtual screen, a material adding control used for adding the screen display material in the virtual screen may be displayed in the picture editing sub-region. After receiving a trigger operation acting on the material adding control, it may jump to a storage space used for storing the screen display material. After receiving a selection operation acting on at least one screen display material under the storage space, the selected screen display material may be determined. Further, the selected screen display material may be added to the virtual screen.

On the basis of the above-described embodiment, after receiving a trigger operation acting on the added screen display material corresponding to the virtual screen, the added screen display material may be displayed in the picture preview region, and at least one of a playback control, a pause control, and a deleting control may be displayed in the picture editing sub-region. The playback control may be used for controlling playback of the screen display material in the virtual screen. The pause control may be used for controlling pausing playback of the screen display material played in the virtual screen. The deleting control may be used for deleting the added screen display material corresponding to the virtual screen. After receiving a control trigger operation acting on the playback control, controlling to play the screen display material in the virtual screen. After receiving a control trigger operation acting on the pause control, controlling to pause the playback of the screen display material played in the virtual screen. After receiving a control trigger operation acting on the deleting control, the added screen display material corresponding to the virtual screen may be deleted.

On the basis of the above-described embodiment, a trigger operation acting on the signal source setting sub-item may be received, so that at least one signal source item may be displayed in a form of a dropdown list. After receiving a selection operation acting on the signal source item, the selected signal source may be determined. Further, the configured screen display material may be obtained based on the signal source.

S540: receiving a lens setting operation input based on the lens editing sub-region, and taking the picture displayed in the picture preview region as a broadcast picture of the multimedia data under a lens set based on the lens setting operation.

In the technical solution of the embodiments of the present disclosure, in a case where the virtual scene picture displayed in the picture preview region includes the virtual screen, by receiving the virtual screen configuration operation for the virtual screen configuration item, the configured screen display material is taken as the scene main body picture, and the scene main body picture is displayed on the virtual screen, which can implement personalized configuration of the content displayed on the virtual screen, and enrich the picture content of the multimedia data.

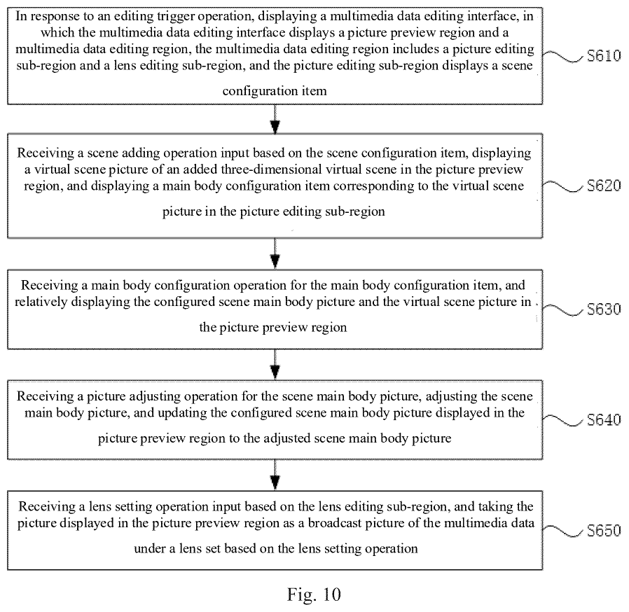

FIG. 10 is a schematic flow chart of an editing method of multimedia data provided by embodiments of the present disclosure. In the technical solution of this embodiment, on the basis of the above-described embodiment, optionally, after the relatively displaying the configured scene main body picture and the virtual scene picture in the picture preview region, the method further includes: receiving a picture adjusting operation for the scene main body picture, and adjusting the scene main body picture, in which the picture adjusting operation includes at least one of a group consisting of picture size adjustment, picture color adjustment, picture brightness adjustment, picture sharpening parameter adjustment, picture contrast adjustment, picture display direction adjustment, and picture position adjustment. The description of this embodiment may be referred to for specific implementation. Technical features that are the same as or similar to the foregoing embodiments will not be repeated here.

As shown in FIG. 10, the method according to this embodiment may specifically include:

S610: in response to an editing trigger operation, displaying a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item.

S620: receiving a scene adding operation input based on the scene configuration item, displaying a virtual scene picture of an added three-dimensional virtual scene in the picture preview region, and displaying a main body configuration item corresponding to the virtual scene picture in the picture editing sub-region.

S630: receiving a main body configuration operation for the main body configuration item, and relatively displaying the configured scene main body picture and the virtual scene picture in the picture preview region.

S640: receiving a picture adjusting operation for the scene main body picture, adjusting the scene main body picture, and updating the configured scene main body picture displayed in the picture preview region to the adjusted scene main body picture.

The picture adjusting operation may be understood as an operation used for adjusting the scene main body picture. The picture adjusting operation may include at least one of a group consisting of picture size adjustment, picture color adjustment, picture brightness adjustment, picture sharpening parameter adjustment, picture contrast adjustment, picture display direction adjustment, and picture position adjustment. Picture size adjustment may include cropping, zooming in and zooming out the scene main body picture.

In the embodiments of the present disclosure, a trigger operation acting on the main body configuration item is received, so that a picture adjustment interface used for adjusting the scene main body picture may be displayed. The picture adjustment interface may display a picture adjustment item used for adjusting the scene main body picture. The picture adjustment item may include at least one of a group consisting of: a picture cropping control, a picture zooming-in control, a picture zooming-out control, a picture color adjustment item, a picture brightness adjustment item, a picture sharpening parameter adjustment item, a picture contrast adjustment item, a picture display direction adjustment item, and a picture display coordinate setting item. After receiving a control trigger operation acting on any picture adjustment item in the picture adjustment interface, the scene main body picture may be adjusted based on a parameter of the set picture adjustment item.

It may be understood that the picture cropping control may be used for cropping the scene main body picture. The picture zooming-in control may be used for zooming in the scene main body picture. The picture zooming-out control may be used for zooming out the scene main body picture. The picture color adjustment item may be used for adjusting a color of the scene main body picture. The picture brightness adjustment item may be used for adjusting brightness of the scene main body picture. The picture sharpening parameter adjustment item may be used for adjusting a sharpening parameter of the scene main body picture, to modify a sharpening effect of the scene main body picture. The picture contrast adjustment item may be used for adjusting brightness contrast of the scene main body picture. The picture display direction adjustment item may be used for adjusting a display direction of the scene main body picture. The picture display coordinate setting item may be used for adjusting display coordinates of the scene main body picture.

On the basis of the above-described embodiment, the editing method of multimedia data further includes: receiving a reference object adding operation of inputting a preset size for the virtual scene picture, and displaying the added reference object in the virtual scene picture; receiving a position adjusting operation for the reference object, and adjusting a display position of the reference object in the virtual scene picture.

The reference object adding operation may be understood as an operation used for adding a reference object of a preset size in the virtual scene picture. The reference object may be a two-dimensional image, or may also be a three-dimensional model. In the embodiments of the present disclosure, a three-dimensional character model of a preset size is taken as a reference object. In a case where the reference object is a three-dimensional character model, the preset size may be a height of the preset three-dimensional character model. The preset size may be a size preset for the reference object according to actual needs.

In the embodiments of the present disclosure, the receiving a reference object adding operation of inputting a preset size for the virtual scene picture, and displaying the added reference object in the virtual scene picture, may include: receiving a trigger operation acting on the scene material configuration item in the picture editing sub-region, and displaying a material adding control used for adding the scene material in the picture editing sub-region. After receiving a control trigger operation acting on the material adding control, a material display interface including at least one scene material may be displayed. The material display interface may display at least one reference object item. After receiving a selection operation acting on the reference object item in the material display interface, the selected reference object item may be determined, and the reference object of the selected reference object item may be displayed in the virtual scene picture in the picture preview region.

It should be noted that in the embodiments of the present disclosure, after adding the reference object to the virtual scene picture, the scene main body picture in the virtual scene picture may be adjusted based on the reference object, so that a realistic effect of the multimedia data picture can be improved.

In the embodiments of the present disclosure, the receiving a position adjusting operation for the reference object, and adjusting a display position of the reference object in the virtual scene picture, may include: receiving a dragging operation acting on the reference object of the virtual scene picture in the picture preview region. Based on the dragging operation, a display position of the reference object in the virtual scene picture is adjusted.

Optionally, after the receiving a reference object adding operation of inputting a preset size for the virtual scene picture, the editing method of multimedia data further includes: displaying a coordinate configuration item corresponding to the reference object. The coordinate configuration item may be used for configuring display coordinates of the reference object in the three-dimensional virtual scene. The receiving a position adjusting operation for the reference object, and adjusting a display position of the reference object in the virtual scene picture, may include: receiving a dragging operation acting on the reference object, adjusting the reference object to a dragging position in the virtual scene picture, and updating coordinate information in the coordinate configuration item based on the coordinate information of the dragging position; and/or, receiving a coordinate configuration operation for the coordinate configuration item, and adjusting the reference object to a position corresponding to the configured coordinate information in the virtual scene picture for display.

The dragging position may be understood as a position obtained after adjusting the display position of the reference object based on the dragging operation acting on the reference object. The advantage of updating the coordinate information in the coordinate configuration item based on the coordinate information of the dragging position is that consistency between the coordinate information of the dragging position and the coordinate information in the coordinate configuration item is ensured, so that a user can timely learn a coordinate change situation of the reference object display position.

The receiving a coordinate configuration operation for the coordinate configuration item, and adjusting the reference object to the position corresponding to the configured coordinate information in the virtual scene picture for display, may include: after receiving the coordinate information input based on the coordinate configuration item, taking the input coordinate information as the coordinate information configured for the reference object in the virtual scene picture. Further, the reference object may be adjusted to the position corresponding to the configured coordinate information in the virtual scene picture for display.

In an application scenario, the reference object and a scene main body to be adjusted in the multimedia data picture may be adjusted to a preset position for comparison display; and further, position and/or size information of the scene main body to be adjusted may be adjusted according to size information of the reference object.

S650: receiving a lens setting operation input based on the lens editing sub-region, and taking the picture displayed in the picture preview region as a broadcast picture of the multimedia data under a lens set based on the lens setting operation.

In the technical solution of the embodiments of the present disclosure, by receiving the picture adjusting operation for the scene main body picture, the scene main body picture is adjusted, so that picture size, picture color, picture brightness, picture sharpening parameter, picture contrast, picture display direction and picture position of the scene main body picture may be adjusted, which further improves quality of the scene main body picture.

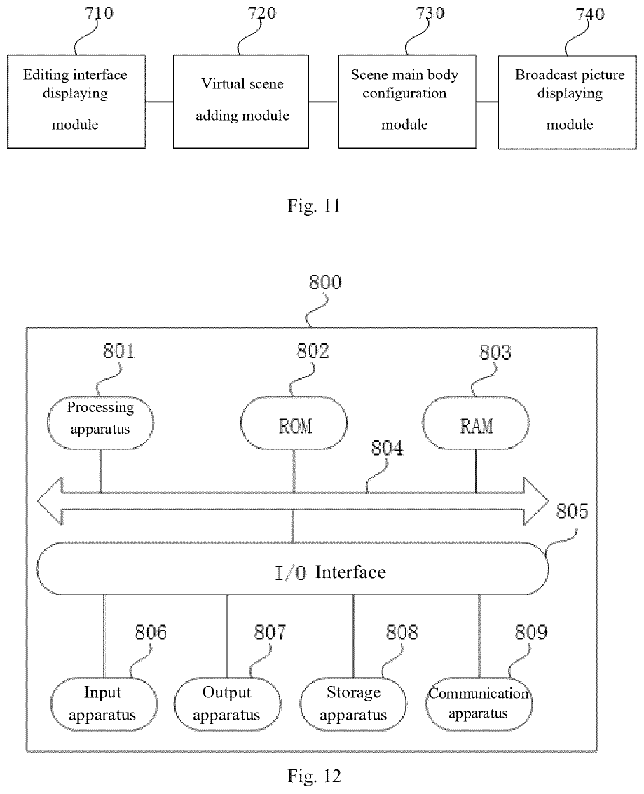

FIG. 11 is a structural schematic diagram of an editing apparatus of multimedia data provided by embodiments of the present disclosure, as shown in FIG. 11, the apparatus includes an editing interface displaying module 710, a virtual scene adding module 720, a scene main body configuration module 730, and a broadcast picture displaying module 740.

The editing interface displaying module 710 is configured to, in response to an editing trigger operation, display a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item; the virtual scene adding module 720 is configured to receive a scene adding operation input based on the scene configuration item, display a virtual scene picture of an added three-dimensional virtual scene in the picture preview region, and display a main body configuration item corresponding to the virtual scene picture in the picture editing sub-region; the scene main body configuration module 730 is configured to receive a main body configuration operation for the main body configuration item, and relatively display a configured scene main body picture and the virtual scene picture in the picture preview region; the broadcast picture displaying module 740 is configured to receive a lens setting operation input based on the lens editing sub-region, and take a picture displayed in the picture preview region as a broadcast picture of the multimedia data under a lens set based on the lens setting operation.

In the technical solution of the embodiments of the present disclosure, by receiving the editing trigger operation, the multimedia data editing interface is displayed, the multimedia data editing interface displays the picture preview region and the multimedia data editing region, the multimedia data editing region includes the picture editing sub-region and the lens editing sub-region, and the picture editing sub-region displays the scene configuration item, providing the user with a richer interactive interface. By receiving the scene adding operation input based on the scene configuration item, the virtual scene picture of the added three-dimensional virtual scene is displayed in the picture preview region, and the main body configuration item corresponding to the virtual scene picture is displayed in the picture editing sub-region; and by receiving the main body configuration operation for the main body configuration item, the configured scene main body picture and the virtual scene picture are relatively displayed in the picture preview region, which can implement flexible personalized editing of the virtual scene picture and the scene main body picture. On this basis, by receiving the lens setting operation input based on the lens editing sub-region, the picture displayed in the picture preview region is taken as the broadcast picture of the multimedia data under the bound lens, which implements flexible configuration of the broadcast picture of the multimedia data.

On the basis of the above optional technical solutions, optionally, the editing apparatus of multimedia data further includes a scene picture adjusting module, the scene picture adjusting module is used for receiving a scene picture adjusting operation for the virtual scene picture displayed in the picture preview region; determining a camera parameter of a virtual camera in the three-dimensional virtual scene based on the scene picture adjusting operation; and displaying the virtual scene picture of the three-dimensional virtual scene under the camera parameter in the picture preview region.

On the basis of the above optional technical solutions, optionally, the editing apparatus of multimedia data further includes a scene picture saving module, the scene picture saving module is used for receiving a scene picture saving operation for the virtual scene picture displayed in the picture preview region, generating a lens configuration item based on the camera parameter corresponding to the virtual scene picture, and displaying the lens configuration item in the lens editing sub-region.

On the basis of the above optional technical solutions, optionally, the editing apparatus of multimedia data further includes a lens configuration item adjusting module, the lens configuration item adjusting module is used for receiving a display adjusting operation for at least one lens configuration item, and adjusting a display mode of the at least one lens configuration item in a lens configuration sub-region, in which the display adjusting operation includes a display position adjusting operation and/or a display quantity adjusting operation.

On the basis of the above optional technical solutions, optionally, the main body configuration item includes a image matting material configuration item; correspondingly, the scene main body configuration module 730 is used for receiving an image matting material configuration operation for the image matting material configuration item, performing image matting processing on a configured image matting material to obtain the scene main body picture, and relatively displaying the scene main body picture and the virtual scene picture in the picture preview region.

On the basis of the above optional technical solutions, optionally, the main body configuration item includes a scene material configuration item; correspondingly, the scene main body configuration module 730 is used for receiving a scene material configuration operation for the scene material configuration item, taking a configured scene material picture as the scene main body picture, and relatively displaying the scene main body picture and the virtual scene picture in the picture preview region.

On the basis of the above optional technical solutions, optionally, the main body configuration item includes a virtual screen configuration item; correspondingly, the scene main body configuration module 730 is used for, in response to the virtual scene picture displayed in the picture preview region including a virtual screen, receiving a virtual screen configuration operation for the virtual screen configuration item, taking a configured screen display material as the scene main body picture, and displaying the scene main body picture in the virtual screen.

On the basis of the above optional technical solutions, optionally, the editing apparatus of multimedia data further includes a scene main body picture adjusting operation module, correspondingly, scene main body picture adjusting operation module is used for, after the relatively displaying the configured scene main body picture and the virtual scene picture in the picture preview region, receiving a picture adjusting operation for the scene main body picture, and adjusting the scene main body picture, in which the picture adjusting operation includes at least one of picture size adjustment, picture color adjustment, picture brightness adjustment, picture sharpening parameter adjustment, picture contrast adjustment, picture display direction adjustment, and picture position adjustment.

On the basis of the above optional technical solutions, optionally, the editing apparatus of multimedia data further includes a reference object operation module, the reference object operation module includes a reference object adding unit and a reference object position adjusting unit.

The reference object adding unit is used for receiving a reference object adding operation of inputting a preset size for the virtual scene picture, and displaying an added reference object in the virtual scene picture; and the reference object position adjusting unit is used for receiving a position adjusting operation for the reference object, and adjusting a display position of the reference object in the virtual scene picture.

On the basis of the above optional technical solutions, optionally, the editing apparatus of multimedia data further includes a coordinate configuration item displaying module, which is used for, after the receiving a reference object adding operation of inputting a preset size for the virtual scene picture, displaying a coordinate configuration item corresponding to the reference object; correspondingly, the reference object position adjusting unit is used for receiving a dragging operation acting on the reference object, adjusting the reference object to a dragging position in the virtual scene picture, and updating coordinate information in the coordinate configuration item based on coordinate information of the dragging position; and/or, receiving a coordinate configuration operation for the coordinate configuration item, and adjusting the reference object to a position corresponding to configured coordinate information in the virtual scene picture for display.

On the basis of the above optional technical solutions, optionally, the lens setting operation includes a lens binding operation; and the lens binding operation is used for binding the virtual scene picture and/or the scene main body picture with an operated lens; the broadcast picture displaying module 740 is used for receiving a lens binding operation input based on the lens editing sub-region, and taking the picture displayed in the picture preview region as a broadcast picture of the multimedia data under a lens bound based on the lens binding operation.

The editing apparatus of multimedia data provided by the embodiments of the present disclosure can execute the editing method of multimedia data provided by any embodiment of the present disclosure, and has corresponding functional modules and beneficial effects for executing the methods.

It is worth noting that the various units and modules included in the above apparatus are only divided according to functional logic, but are not limited to the above division, as long as they can achieve the corresponding functions. In addition, the specific names of each functional unit are only for the purpose of distinguishing them from each other and are not intended to limit the protection scope of the embodiments of the present disclosure.

FIG. 12 is a structural schematic diagram of an electronic device provided by embodiments of the present disclosure. In the following, referring to FIG. 12, which illustrates a structural schematic diagram of an electronic device 800 suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable multimedia player (PMP), a vehicle-mounted terminal (e.g., a vehicle-mounted navigation terminal), or the like, and fixed terminals such as a digital TV, a desktop computer, or the like. The electronic device illustrated in FIG. 12 is merely an example, and should not pose any limitation to the functions and the range of use of the embodiments of the present disclosure.

As illustrated in FIG. 12, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 12 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

The names of messages or information exchanged between a plurality of apparatuses in the implementations of the present disclosure are used for illustrative purposes only, and are not used to limit the scope of these messages or information.

The electronic device provided by the embodiments of the present disclosure and the editing method of multimedia data provided by the embodiments of the present disclosure belong to the same inventive concept. Technical details not described in detail in this embodiment can be found in the above embodiments, and this embodiment has the same beneficial effects as the above embodiments.

Embodiments of the present disclosure provides a computer storage medium storing a computer program thereon, when the program is executed by a processor, the editing method of multimedia data provided by the above embodiments is implemented.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: in response to an editing trigger operation, display a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item;
receiving a scene adding operation input based on the scene configuration item, displaying a virtual scene picture of an added three-dimensional virtual scene in the picture preview region, and displaying a main body configuration item corresponding to the virtual scene picture in the picture editing sub-region;
receiving a main body configuration operation for the main body configuration item, and relatively displaying a configured scene main body picture and the virtual scene picture in the picture preview region; and
receiving a lens setting operation input based on the lens editing sub-region, and taking a picture displayed in the picture preview region as a broadcast picture of the multimedia data under a lens set based on the lens setting operation.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be described as a unit that acquires at least two Internet Protocol addresses.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, example one provides an editing method of multimedia data, which includes:
in response to an editing trigger operation, displaying a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item;
receiving a scene adding operation input based on the scene configuration item, displaying a virtual scene picture of an added three-dimensional virtual scene in the picture preview region, and displaying a main body configuration item corresponding to the virtual scene picture in the picture editing sub-region;
receiving a main body configuration operation for the main body configuration item, and relatively displaying a configured scene main body picture and the virtual scene picture in the picture preview region; and
receiving a lens setting operation input based on the lens editing sub-region, and taking a picture displayed in the picture preview region as a broadcast picture of the multimedia data under a lens set based on the lens setting operation.

According to one or more embodiments of the present disclosure, example two provides an editing method of multimedia data, which further includes: receiving a scene picture adjusting operation for the virtual scene picture displayed in the picture preview region; determining a camera parameter of a virtual camera in the three-dimensional virtual scene based on the scene picture adjusting operation; and displaying the virtual scene picture of the three-dimensional virtual scene under the camera parameter in the picture preview region.

According to one or more embodiments of the present disclosure, example three provides an editing method of multimedia data, which further includes: receiving a scene picture saving operation for the virtual scene picture displayed in the picture preview region, generating a lens configuration item based on the camera parameter corresponding to the virtual scene picture, and displaying the lens configuration item in the lens editing sub-region.

According to one or more embodiments of the present disclosure, example four provides an editing method of multimedia data, which further includes: receiving a display adjusting operation for at least one lens configuration item, and adjusting a display mode of the at least one lens configuration item in a lens configuration sub-region, in which the display adjusting operation includes a display position adjusting operation and/or a display quantity adjusting operation.

According to one or more embodiments of the present disclosure, example five provides an editing method of multimedia data, which includes: the main body configuration item including an image matting material configuration item; the receiving a main body configuration operation for the main body configuration item, and relatively displaying the configured scene main body picture and the virtual scene picture in the picture preview region, includes:
receiving an image matting material configuration operation for the image matting material configuration item, performing image matting processing on a configured image matting material to obtain the scene main body picture, and relatively displaying the scene main body picture and the virtual scene picture in the picture preview region.

According to one or more embodiments of the present disclosure, example six provides an editing method of multimedia data, which includes: the main body configuration item including a scene material configuration item; the receiving a main body configuration operation for the main body configuration item, and relatively displaying the configured scene main body picture and the virtual scene picture in the picture preview region, includes:
receiving a scene material configuration operation for the scene material configuration item, taking a configured scene material picture as the scene main body picture, and relatively displaying the scene main body picture and the virtual scene picture in the picture preview region.

According to one or more embodiments of the present disclosure, example seven provides an editing method of multimedia data, which includes: the main body configuration item including a virtual screen configuration item; the receiving a main body configuration operation for the main body configuration item, and relatively displaying the configured scene main body picture and the virtual scene picture in the picture preview region, includes:
in response to the virtual scene picture displayed in the picture preview region including a virtual screen, receiving a virtual screen configuration operation for the virtual screen configuration item, taking a configured screen display material as the scene main body picture, and displaying the scene main body picture in the virtual screen.

According to one or more embodiments of the present disclosure, example eight provides an editing method of multimedia data, after the relatively displaying the configured scene main body picture and the virtual scene picture in the picture preview region, the editing method further includes:
receiving a picture adjusting operation for the scene main body picture, and adjusting the scene main body picture, in which the picture adjusting operation includes at least one of picture size adjustment, picture color adjustment, picture brightness adjustment, picture sharpening parameter adjustment, picture contrast adjustment, picture display direction adjustment, and picture position adjustment.

According to one or more embodiments of the present disclosure, example nine provides an editing method of multimedia data, which further includes:
receiving a reference object adding operation of inputting a preset size for the virtual scene picture, and displaying an added reference object in the virtual scene picture; and
receiving a position adjusting operation for the reference object, and adjusting a display position of the reference object in the virtual scene picture.

According to one or more embodiments of the present disclosure, example ten provides an editing method of multimedia data, after the receiving a reference object adding operation of inputting a preset size for the virtual scene picture, the editing method further includes: displaying a coordinate configuration item corresponding to the reference object;
the receiving a position adjusting operation for the reference object, and adjusting a display position of the reference object in the virtual scene picture, includes:
receiving a dragging operation acting on the reference object, adjusting the reference object to a dragging position in the virtual scene picture, and updating coordinate information in the coordinate configuration item based on coordinate information of the dragging position; and/or,
receiving a coordinate configuration operation for the coordinate configuration item, and adjusting the reference object to a position corresponding to configured coordinate information in the virtual scene picture for display.

According to one or more embodiments of the present disclosure, example eleven provides an editing method of multimedia data, the lens setting operation includes a lens binding operation; and the lens binding operation is used for binding the virtual scene picture and/or the scene main body picture with an operated lens;
the receiving a lens setting operation input based on the lens editing sub-region, and taking the picture displayed in the picture preview region as a broadcast picture of the multimedia data under a lens set based on the lens setting operation, includes: receiving a lens binding operation input based on the lens editing sub-region, and taking the picture displayed in the picture preview region as a broadcast picture of the multimedia data under a lens bound based on the lens binding operation.

According to one or more embodiments of the present disclosure, example twelve provides an editing apparatus of multimedia data, which includes:
an editing interface displaying module, configured to, in response to an editing trigger operation, display a multimedia data editing interface, in which the multimedia data editing interface displays a picture preview region and a multimedia data editing region, the multimedia data editing region includes a picture editing sub-region and a lens editing sub-region, and the picture editing sub-region displays a scene configuration item;
a virtual scene adding module, configured to receive a scene adding operation input based on the scene configuration item, display a virtual scene picture of an added three-dimensional virtual scene in the picture preview region, and display a main body configuration item corresponding to the virtual scene picture in the picture editing sub-region;
a scene main body configuration module, configured to receive a main body configuration operation for the main body configuration item, and relatively display a configured scene main body picture and the virtual scene picture in the picture preview region; and
a broadcast picture displaying module, configured to receive a lens setting operation input based on the lens editing sub-region, and take a picture displayed in the picture preview region as a broadcast picture of the multimedia data under a lens set based on the lens setting operation.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An editing method of multimedia data, comprising:
in response to an editing trigger operation, displaying a multimedia data editing interface, wherein the multimedia data editing interface displays a picture preview region and a multimedia data editing region, the multimedia data editing region comprises a picture editing sub-region and a lens editing sub-region, and the picture editing sub-region displays a scene configuration item;
receiving a scene adding operation input based on the scene configuration item, displaying a virtual scene picture of an added three-dimensional virtual scene in the picture preview region, and displaying a main body configuration item corresponding to the virtual scene picture in the picture editing sub-region;
receiving a main body configuration operation for the main body configuration item, and relatively displaying a configured scene main body picture and the virtual scene picture in the picture preview region; and
receiving a lens setting operation input based on the lens editing sub-region, and taking a picture displayed in the picture preview region as a broadcast picture of the multimedia data under a lens set based on the lens setting operation.

2. The editing method of multimedia data according to claim 1, further comprising:
receiving a scene picture adjusting operation for the virtual scene picture displayed in the picture preview region;
determining a camera parameter of a virtual camera in the three-dimensional virtual scene based on the scene picture adjusting operation; and
displaying the virtual scene picture of the three-dimensional virtual scene under the camera parameter in the picture preview region.

3. The editing method of multimedia data according to claim 2, further comprising:
receiving a scene picture saving operation for the virtual scene picture displayed in the picture preview region, generating a lens configuration item based on the camera parameter corresponding to the virtual scene picture, and displaying the lens configuration item in the lens editing sub-region.

4. The editing method of multimedia data according to claim 1, further comprising:
receiving a display adjusting operation for at least one lens configuration item, and adjusting a display mode of the at least one lens configuration item in a lens configuration sub-region, wherein the display adjusting operation comprises a display position adjusting operation and/or a display quantity adjusting operation.

5. The editing method of multimedia data according to claim 1, wherein the main body configuration item comprises an image matting material configuration item;
the receiving a main body configuration operation for the main body configuration item, and relatively displaying the configured scene main body picture and the virtual scene picture in the picture preview region, comprises:
receiving an image matting material configuration operation for the image matting material configuration item, performing image matting processing on a configured image matting material to obtain the scene main body picture, and relatively displaying the scene main body picture and the virtual scene picture in the picture preview region.

6. The editing method of multimedia data according to claim 1, wherein the main body configuration item comprises a scene material configuration item;
the receiving a main body configuration operation for the main body configuration item, and relatively displaying the configured scene main body picture and the virtual scene picture in the picture preview region, comprises:
receiving a scene material configuration operation for the scene material configuration item, taking a configured scene material picture as the scene main body picture, and relatively displaying the scene main body picture and the virtual scene picture in the picture preview region.

7. The editing method of multimedia data according to claim 1, wherein the main body configuration item comprises a virtual screen configuration item;
the receiving a main body configuration operation for the main body configuration item, and relatively displaying the configured scene main body picture and the virtual scene picture in the picture preview region, comprises:
in response to the virtual scene picture displayed in the picture preview region comprising a virtual screen, receiving a virtual screen configuration operation for the virtual screen configuration item, taking a configured screen display material as the scene main body picture, and displaying the scene main body picture in the virtual screen.

8. The editing method of multimedia data according to claim 1, wherein after the relatively displaying the configured scene main body picture and the virtual scene picture in the picture preview region, the editing method of multimedia data further comprises:
receiving a picture adjusting operation for the scene main body picture, and adjusting the scene main body picture, wherein the picture adjusting operation comprises at least one of picture size adjustment, picture color adjustment, picture brightness adjustment, picture sharpening parameter adjustment, picture contrast adjustment, picture display direction adjustment, and picture position adjustment.

9. The editing method of multimedia data according to claim 8, further comprising:
receiving a reference object adding operation of inputting a preset size for the virtual scene picture, and displaying an added reference object in the virtual scene picture; and
receiving a position adjusting operation for the reference object, and adjusting a display position of the reference object in the virtual scene picture.

10. The editing method of multimedia data according to claim 9, wherein after the receiving a reference object adding operation of inputting a preset size for the virtual scene picture, the editing method of multimedia data further comprises:
displaying a coordinate configuration item corresponding to the reference object;
the receiving a position adjusting operation for the reference object, and adjusting a display position of the reference object in the virtual scene picture, comprises:
receiving a dragging operation acting on the reference object, adjusting the reference object to a dragging position in the virtual scene picture, and updating coordinate information in the coordinate configuration item based on coordinate information of the dragging position; and/or,
receiving a coordinate configuration operation for the coordinate configuration item, and adjusting the reference object to a position corresponding to configured coordinate information in the virtual scene picture for display.

11. The editing method of multimedia data according to claim 1, wherein the lens setting operation comprises a lens binding operation; and the lens binding operation is used for binding the virtual scene picture and/or the scene main body picture with an operated lens;
the receiving a lens setting operation input based on the lens editing sub-region, and taking the picture displayed in the picture preview region as a broadcast picture of the multimedia data under a lens set based on the lens setting operation, comprises:
receiving a lens binding operation input based on the lens editing sub-region, and taking the picture displayed in the picture preview region as a broadcast picture of the multimedia data under a lens bound based on the lens binding operation.

12. (canceled)

13. An electronic device, comprising:
one or more processors; and
a storage apparatus, configured to store one or more programs,
wherein the one or more programs, when executed by the one or more processors, cause the one or more processors to:
in response to an editing trigger operation, display a multimedia data editing interface, wherein the multimedia data editing interface displays a picture preview region and a multimedia data editing region, the multimedia data editing region comprises a picture editing sub-region and a lens editing sub-region, and the picture editing sub-region displays a scene configuration item;
receive a scene adding operation input based on the scene configuration item, display a virtual scene picture of an added three-dimensional virtual scene in the picture preview region, and display a main body configuration item corresponding to the virtual scene picture in the picture editing sub-region;
receive a main body configuration operation for the main body configuration item, and relatively display a configured scene main body picture and the virtual scene picture in the picture preview region; and
receive a lens setting operation input based on the lens editing sub-region, and take a picture displayed in the picture preview region as a broadcast picture of the multimedia data under a lens set based on the lens setting operation.

14. A non-transitory storage medium, having computer executable instructions stored thereon, wherein the computer executable instructions, when executed by a computer processor, are used for executing an editing method of multimedia data, the method comprises:
in response to an editing trigger operation, displaying a multimedia data editing interface, wherein the multimedia data editing interface displays a picture preview region and a multimedia data editing region, the multimedia data editing region comprises a picture editing sub-region and a lens editing sub-region, and the picture editing sub-region displays a scene configuration item;
receiving a scene adding operation input based on the scene configuration item, displaying a virtual scene picture of an added three-dimensional virtual scene in the picture preview region, and displaying a main body configuration item corresponding to the virtual scene picture in the picture editing sub-region;
receiving a main body configuration operation for the main body configuration item, and relatively displaying a configured scene main body picture and the virtual scene picture in the picture preview region; and
receiving a lens setting operation input based on the lens editing sub-region, and taking a picture displayed in the picture preview region as a broadcast picture of the multimedia data under a lens set based on the lens setting operation.

15. The electronic device according to claim 13, wherein the one or more processors are further caused to:
receive a scene picture adjusting operation for the virtual scene picture displayed in the picture preview region;
determine a camera parameter of a virtual camera in the three-dimensional virtual scene based on the scene picture adjusting operation; and
display the virtual scene picture of the three-dimensional virtual scene under the camera parameter in the picture preview region.

16. The electronic device according to claim 15, wherein the one or more processors are further caused to:
receive a scene picture saving operation for the virtual scene picture displayed in the picture preview region, generate a lens configuration item based on the camera parameter corresponding to the virtual scene picture, and display the lens configuration item in the lens editing sub-region.

17. The electronic device according to claim 13, wherein the one or more processors are further caused to:
receive a display adjusting operation for at least one lens configuration item, and adjust a display mode of the at least one lens configuration item in a lens configuration sub-region, wherein the display adjusting operation comprises a display position adjusting operation and/or a display quantity adjusting operation.

18. The electronic device according to claim 13, wherein the main body configuration item comprises an image matting material configuration item;
the one or more processors are further caused to:
receive an image matting material configuration operation for the image matting material configuration item, perform image matting processing on a configured image matting material to obtain the scene main body picture, and relatively display the scene main body picture and the virtual scene picture in the picture preview region.

19. The electronic device according to claim 13, wherein the main body configuration item comprises a scene material configuration item;
the one or more processors are further caused to:
receive a scene material configuration operation for the scene material configuration item, take a configured scene material picture as the scene main body picture, and relatively display the scene main body picture and the virtual scene picture in the picture preview region.

20. The electronic device according to claim 13, wherein the main body configuration item comprises a virtual screen configuration item;
the one or more processors are further caused to:
in response to the virtual scene picture displayed in the picture preview region comprising a virtual screen, receive a virtual screen configuration operation for the virtual screen configuration item, take a configured screen display material as the scene main body picture, and display the scene main body picture in the virtual screen.
